(19) United States
(12) Patent Application Publication
(10) Pub. No.: US 2012/0169535 A1
(43) Pub. Date: Jul. 5, 2012

(54) AFFECTING ELECTRONIC DEVICE POSITIONING FUNCTIONS BASED ON MEASURED COMMUNICATION NETWORK SIGNAL PARAMETERS

(75) Inventors: Seung-Hyun Kong, Seoul (KR); Zoltan F. Biacs, San Mateo, CA (US); Ju-Yong Do, Palo Alto, CA (US)

(73) Assignee: QUALCOMM Incorporated, San Diego, CA (US)

(21) Appl. No.: 12/985,007

(22) Filed: Jan. 5, 2011

(51) Int. Cl. G01S 19/12

(52) U.S. Cl. 342/357.49

(57) ABSTRACT

Techniques are provided which may be implemented in various methods and apparatuses to allow an electronic device to determine when it transitions between certain environments which may be perceived, for example, from observations associated with wireless signals transmitted by a wireless communication network. In response to an environment transition determination, the techniques further allow for one or more positioning functions to be operatively affected in some manner.

### BACKGROUND

1. Field

The subject matter disclosed herein relates to electronic devices, and more particularly to methods and apparatuses for use in and/or with an electronic device to support position estimation determination in a wireless operating space having different perceivable (detectable) wireless signaling environments.

2. Information

It is often useful to determine a position of an electronic device with reference to some location scheme. For example, some electronic devices may include a global positioning system (GPS) and/or other like global navigation satellite system (GNSS) receiver that is capable of determining a relative geographical location of the electronic device using an applicable positioning function. For example, some electronic devices, e.g., a mobile station, may be capable of estimating on its own, its relative location based on wireless signals received from a GNSS, or possibly with network support with additional positioning information provided via wireless signal transmitters (e.g. base stations, access points, location beacons, etc.).

There may, however, be situations wherein an electronic device for various reasons may be unable to receive the requisite wireless signals to support a given positioning function. Thus, an electronic device may move to a position wherein the requisite wireless signal transmissions are no longer available for use, e.g., in which wireless signals from a GNSS and/or other like network supported information may be substantially attenuated and/or otherwise affected some manner which precludes their use.

It may be beneficial for an electronic device to determine when certain environment transitions occur and to respond in some manner thereto such that position estimation may continue in some manner.

### SUMMARY

In accordance with certain aspects techniques are provided for affecting operation of a satellite positioning system (SPS) navigation function in an electronic device based, at least in part, on a determination that the electronic device is transitioning or has transitioned from a first environment to a second environment. Such techniques may be implemented using various methods and/or apparatuses within the electronic device and which may allow position estimation to continue in some manner despite changing environments.

By way of example, one method may include determining that the electronic device is transitioning or has transitioned from a first environment to a second environment based, at least in part, on one or more measured signal parameters associated with one or more received wireless signals associated with one or more wireless communication networks. The method may further include associating at least one of the measured signal parameters with at least one operative parameter of an SPS navigation function, and in response to a determination that the electronic device is transitioning or has transitioned from the first environment to the second environment, affecting operation of the SPS navigation function, at least in part, by changing at least one operative parameter.

In certain example implementations, a determination that the electronic device is transitioning or has transitioned from the first environment to the second environment may comprise estimating a position and/or a velocity of the electronic device based, at least in part, on Doppler related information determined using one or more measured signal parameters.

In one method a selection and/or operation of an SPS filtering capability may be affected, for example, based at least in part on estimated position and/or velocity information determined using at least one of the one or more measured signal parameters. In another method an SPS error measurement capability may be affected, for example, based at least in part on signal propagation related information determined using one or more measured signal parameters. In yet another method, for example, an a priori noise measurement and/or an error measurement associated with the operation of an SPS navigation function may be affected based, at least in part, on a measured signal parameter. In certain implementations, for example, a method may comprise affecting an SPS error measurement capability based, at least in part, on signal-to-noise ratio related information determined using one or more measured signal parameters.

In still other examples, a method may comprise affecting at least one signal environment model capability associated with the operation of an SPS navigation function based, at least in part, on a measured signal parameter.

In certain implementations, for example, a method may also comprise affecting operation of the SPS navigation function based further, at least in part, on corresponding historical signal parameter information associated with a received wireless signals (e.g., terrestrial and/or satellite signals). Here, for example, historical signal parameter information may be obtained from one or more other electronic devices.

In certain example implementations, an SPS integration time may be affected based, at least in part, on estimated position and/or velocity information determined using at least one of the one or more measured signal parameters, and/or based at least in part on information associated with the second environment.

In certain example implementations, a selection and/or operation of one or more non-radio sensors may be affected based, at least in part, on estimated position and/or velocity information determined using at least one of the one or more measured signal parameters, and/or based at least in part on information associated with the second environment.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an electronic device within a wireless operating space having different detectable wireless signaling environments, in accordance with an implementation.

FIG. 2 is a schematic block diagram illustrating certain information that may be stored and/or otherwise used in an example electronic device within a wireless operating space having different detectable wireless signaling environments, in accordance with an implementation.

FIG. 3 is a functional flow-diagram illustrating certain features of an example process that may be implemented in an example electronic device within a wireless operating space having different detectable wireless signaling environments, in accordance with an implementation.

### DETAILED DESCRIPTION

In accordance with certain aspects of the present description, various techniques are provided which may be implemented in an electronic device to allow the device to estimate its current position.

By way of example, techniques are provided which may be implemented in various methods and apparatuses to allow an electronic device to determine when it is transitioning or has transitioned (e.g., via movement) between certain environments which may be perceived (detected), for example, from observations associated with wireless signals (e.g., terrestrial and/or satellite signals). The wireless signals may, for example, be associated with a wireless communication network and an environment transition determination may be based, at least in part, on one or more measured signal parameters associated with such wireless signals.

In response to an environment transition determination, the techniques may further allow for one or more positioning functions (e.g., an SPS navigation function) to be operatively affected in some manner. For example, a positioning function may be adapted in some way to better operate in a perceived environment.

In accordance with certain example implementations, an apparatus may be provided for use in and/or as an electronic device, such as, for example, a portable electronic computing and/or communication device, a portable navigation device, and/or the like. Here, for example, such apparatus may comprise various forms of hardware, firmware, and/or a combination of hardware and/or firmware and computer implementable instructions executable thereby. In certain example devices, all or portions of such an apparatus and/or its related processing/functionality may be implemented in one or more integrated circuits.

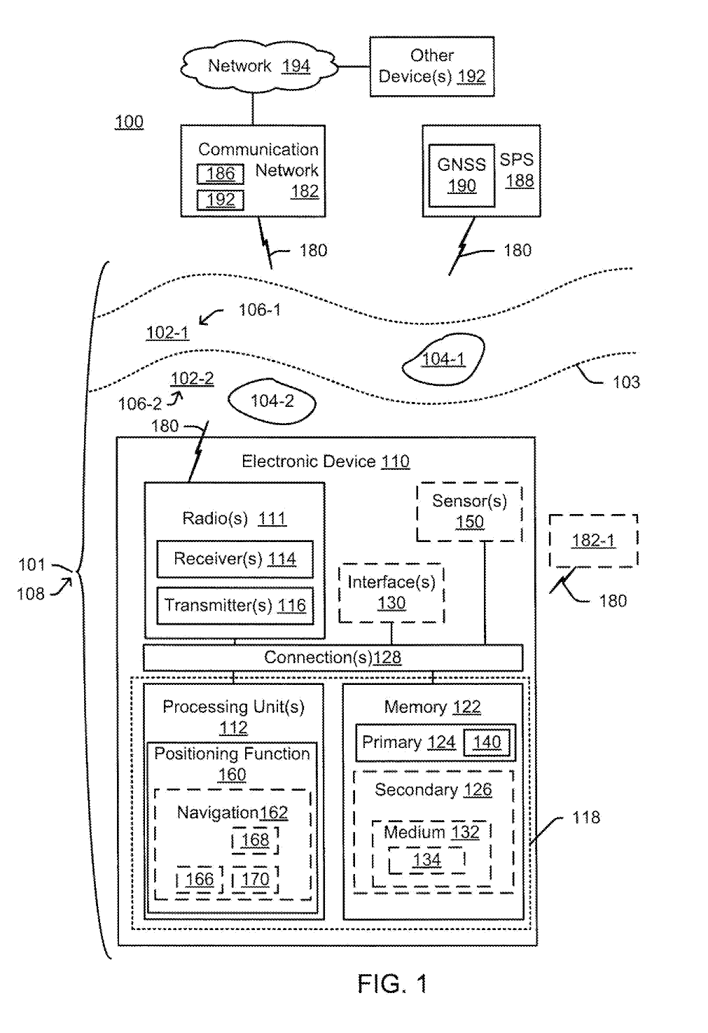

FIG. 1 is a block diagram schematically illustrating certain aspects of an example wireless operating space 100 presenting a plurality of different “environments” 102 within which an electronic device 110 may be located or may become located. Here, for example, a first environment 102-1 and a second environment 102-2 are illustrated as being adjacent to one another alone a boundary region 103. Although illustrated as being separated at about boundary region 103, it should be understood that in certain implementations, for example, two or more “environments” may overlap in some manner and/or one or more “environments” may comprise one or more other “environments (e.g., a nested configuration).

As used herein, the term “environment” refers to at least one region that is at least partially within at least one wireless operating space 100 and which may be at least perceived to be operatively different from at least one other “environment” as determined based, at least in part, on one or more measured signal parameters associated with one or more wireless signals (e.g., terrestrial and/or satellite signals) received by electronic device 110 while entering into, exiting from, and/or otherwise being located within a given region.

By way of example but not limitation, certain environments may comprise different wireless signal transmitters and/or otherwise present various static/dynamic physical features 104, which in some manner affect wireless signal transmissions and/or may relate in some manner to certain operative contexts. For example, one or more physical features 104-1 may affect in some manner one or more wireless signals 180 (e.g., terrestrial and/or satellite signals) that may be received (and possibly transmitted) by an electronic device within environment 102-1. For example, one or more physical features 104-2 may affect in some manner one or more wireless signals 180 that may be received (and possibly transmitted) by an electronic device within environment 102-2. Physical features 104 may, for example, include any natural land formations, various fauna, and/or man-made structures, objects, etc., that may in some manner act to affect wireless signal transmissions.

Physical features 104 may, for example, also be associated with and/or relate in some manner to certain operative contexts. For example, an operative context may identify a farm property, a valley, a city, a building, a campus, an arena, a park, a library, a warehouse, a zoo, a hospital, a shopping mall, a maritime channel/port, etc., for which certain positioning/navigation information and/or associated positioning function(s) may be available for use by an electronic device.

As electronic device 110 is moved from one environment to another environment it may be beneficial to determine that such a transition is occurring, or has occurred and in response to such an environment transition determination possibly affect the operation of a positioning function in some manner.

Several example techniques are provided below that, for example, illustrate how an electronic device may independently (or alternatively with some assistance) may determine a transition from first environment 102-1 to second environment 102-2 based, at least in part, on one or more measured signal parameters 140 associated with wireless signals 180 transmitted by wireless communication network(s) 182. In certain example instances, information obtained from satellites may be also be used to provide additional assistance to terrestrial signal based positioning and vice versa.

For example, in certain situations, first environment 102-1 may take the form of an outdoor environment and second environment 102-2 may take the form of an indoor environment. In other example situations, first environment 102-1 may take the form of a more rural environment and second environment 102-2 may take the form of a more urban environment.

In still other examples, first environment 102-1 may take the form of a relatively non-occluded environment while second environment 102-2 may take the form of a more occluded environment with regard to wireless signaling. In certain example situations, first environment 102-1 may take the form of a less (RF) noisy environment (e.g., non-noisy) and second environment 102-2 may take the form of a relatively more noisy environment. For example, in certain situations, first environment 102-1 may take the form of a relatively more reliable signaling environment while second environment 102-2 may take the form of a less reliable signaling environment (e.g., non-reliable).

In a further illustrated example, as shown in FIG. 1, the first and second environments may represent different indoor spaces 106-1 and 106-2, e.g., located within a common physical structure 108 and/or the like. For example, indoor spaces 106-1 and 106-2 may include different floors, sections, wings, and/or the like associated with an office building.

As illustrated in the example of FIG. 1, electronic device 110 may comprise one or more radios 111 shown here as possibly comprising one or more receivers 114 and/or transmitters 116. Of course, a radio may comprise a transceiver as well. One or more radios 111 may, for example, be provided to receive wireless signals 180 transmitted by communication network 182, a Satellite Positioning System (SPS) 188 (e.g., a Global Navigation Satellite System (GNSS)) and/or the like. One or more radios 111 may be provided to transmit wireless signals 180, for example to one or more other electronic devices 192 associated with communication network 182 and/or otherwise accessible there through, e.g., via a further network 194, and/or the like.

Also, as shown in this example, communication network 182 may include one or more terrestrial-based wireless signal transmitters 186. For example, a communication network 182 may take the form of a cellular network having one or more terrestrial-based wireless signal transmitters 186 that act as base transceiver stations or the like, repeater devices (e.g., providing so-called Fempto-cell, Pico-cell, etc., service coverage), and/or the like.

In other examples, a communication network 182 may take the form of a wireless wide area network or the like, having one or more terrestrial-based wireless signal transmitters 186 that act as access points, and/or the like. In certain examples, a communication network 182 may provide certain positioning services, which may operate independently and/or along with (e.g., augmenting) all or part of SPS 188, a GNSS 190, and/or the like.

Radios 111 may, for example, be capable of supporting one or more computing and communication services, such as, for example, telecommunication services, location/navigation services, and/or other like information and/or services with regard to electronic device 110.

In certain example implementations, electronic device 110 may include a portable electronic device such as a mobile station, e.g., a cellular phone, a smart phone, a personal digital assistant, a portable computing device, a navigation unit, and/or the like or any combination thereof. In other example implementations, electronic device 110 may take the form of one or more integrated circuits, circuit boards, and/or the like that may be operatively enabled for use in another device.

With such examples and others in mind, electronic device 110 may, for example, be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMax, Ultra Mobile Broadband (UMB), and/or the like.

As further illustrated in FIG. 1, in certain implementations, the first and second environments may be intended to be within the coverage area of one or more communication networks and/or positioning systems. However, in certain implementations, different environments may fall within the coverage of certain selected communication networks and/or positioning systems. Hence, in FIG. 1, an optional communication network 182-1 is illustrated as possibly being associated more closely with second environment 102-1.

Electronic device 110, as shown in this example, may also include one or more processing units 112, which may be coupled to a memory 122, e.g., via one or more connections 128 (e.g., one or more electrical conductors, optical fibers, etc.).

In this example, processing unit 112 is illustrated as presently performing a positioning function 160. Positioning function 160 may, for example, process information associated with wireless signals from one or more of a communication network, a positioning system, and/or an SPS, and/or other information associated with one or more other sensors 150, to determine an estimated position (e.g., a relative position or location), velocity, and/or other like measurement.

For example, a positioning function may comprise a navigation function 162 to track or otherwise process SPS/GNSS signals and provide/record information associated with a route (e.g., location/velocity, etc.) of electronic device 110. In another example, a positioning function may comprise a navigation function 162 to track or otherwise process wireless signals transmitted by a positioning system to provide/record information associated with a position/velocity of electronic device 110. In certain example implementations, a navigation function may comprise an SPS and/or GNSS navigation function 166, an SPS and/or GNSS filtering capability 168, and/or the like. In certain example implementations, a navigation function may implement and/or otherwise make use of a position estimation method as represented here by a filter 170. By way of a few non-limiting examples, filter 170 may comprise a Kalman filter, an extended Kalman filter, unscented Kalman filter, a Particle filter, a Bayes filter, and/or the like.

As illustrated in this example, memory 122 may comprise different types and/or purposed data storage mechanisms such as, a primary memory 124 and/or a secondary memory 126. Here, for example, primary memory 124 may comprise read only memory, random access memory, and/or the like, which may store information in the form of data representing measured signal parameters 140, etc. Secondary memory 126 may be similar, and/or may include other forms of data storage and/or apparatuses to access such. For example, secondary memory 126 may comprise and/or access a disk and/or disk drive, an optical disc and/or disc drive, a solid state memory, a smart card, etc. Thus, for example an article of manufacture may comprise a computer readable storage medium 132 may be provided with computer implementable instructions 134 (e.g., implementable by processing unit(s) 112, and/or other like circuitry within electronic device 110). Note that herein the phrase “computer readable storage medium” does not refer to transitory propagating signals.

While processing unit 112 and memory 122 are illustrated as being separate in FIG. 1, it should be understood that one or more, or all of the circuit functions illustrated in electronic device 110 may be combined in various manners. For example, at least a portion of the circuitry/capability of processing unit 112 and/or memory 122 may be provided/combined as part of a multimode modem 118 and/or the like. Multimode modem 118 may, for example, be provided as an integrated circuit chip or chip set to service one or more radio(s) and/or associated communication techniques/protocols.

Electronic device 110 may also include one or more input/output interface(s) 130. Here, for example, one or more user interface mechanisms may be provided through which user inputs may be received, and/or one or more output mechanisms may be provided through which information may be presented to a user.

One or more non-radio sensor(s) 150 may be provided in certain implementations. Here, for example, an accelerometer, a magnetometer, a compass, a barometer, and/or the like may be provided which may generate information that may be useful to one or more functions performed by electronic device 110.

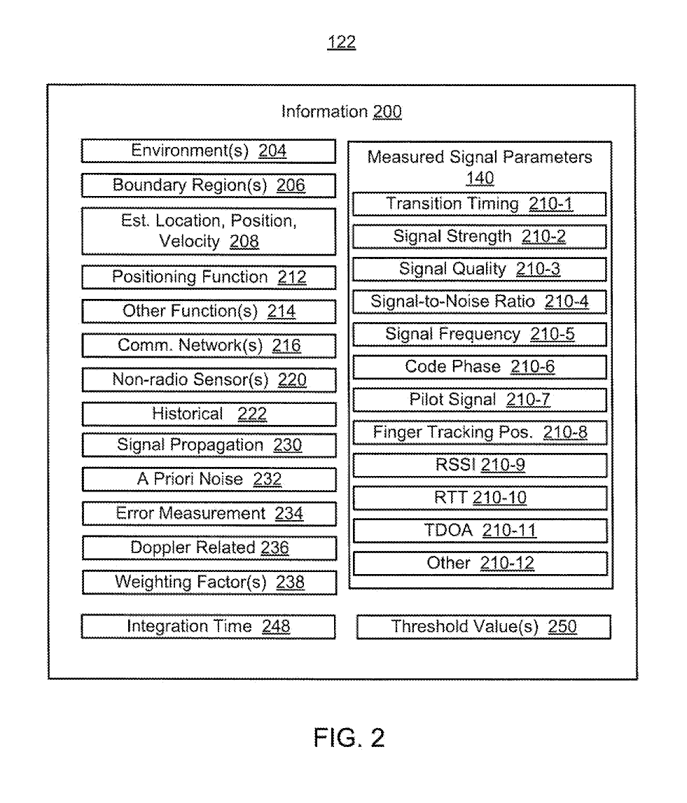

Reference is now made to FIG. 2, which is a block diagram illustrating some example information 200, which may from time to time be stored/accessed using memory 122. The purpose and use of such example information are described in greater detail below with regard to an example process 300.

Information 200 may include, for example, information associated with: one or more environment(s) 204, one or more boundary regions 206, an estimated location/position/velocity 208, a positioning functions 212, other positioning functions 214, one or more wireless communication networks 216, one or more non-radio sensors 220, historical signal parameters 222, perceived signal propagation 230 (e.g., line of sight (LOS), multipath, etc.), a priori noise measurements 232, error measurements 234, Doppler related 236, weighting factors 238, integration times 248, and/or threshold values 250.

Information 200 may, for example, comprise information associated with one or more measured signal parameters 140. For example, a measured signal parameter may relate to a transition timing measurement 210-1, a signal strength measurement 210-2, a signal quality measurement 210-3, a signal-to-noise ratio measurement 210-4, a signal frequency measurement 210-5, a code phase measurement 210-6, a pilot signal measurement 210-7, a finger tracking position measurement 210-8, an RSSI measurement 210-9, an RTT measurement 210-10, a TDOA measurement 210-11, and other like measurements 210-12.

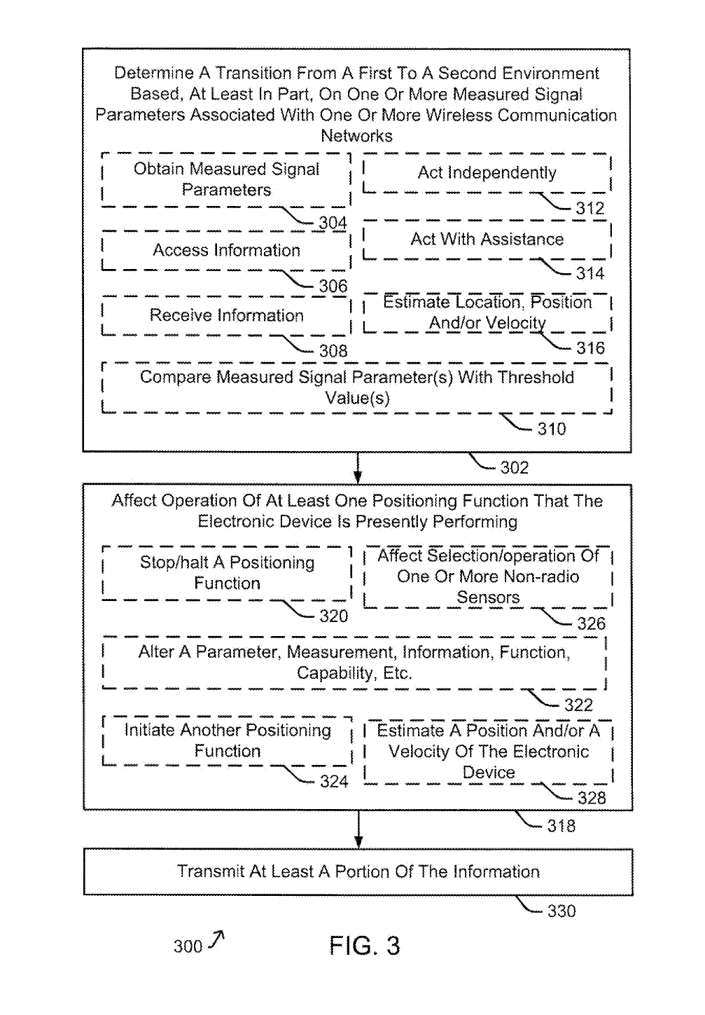

Reference is now made to FIG. 3, which shows a flow-diagram illustrating an example process 300 that may be implemented in and/or with an electronic device, such as, the example electronic device 110 in FIGS. 1 and 2.

At block 302, a transition from a first to a second environment may be determined based, at least in part, on one or more measured signal parameters associated with one or more wireless signals from one or more wireless communication networks. At block 304, measured signal parameters may be obtained, e.g., using one or more radios 111 (FIG. 1). At block 306, information, such as, e.g., information 200 (FIG. 2) may be accessed (read or write) in making such a determination. At block 308, certain information may be received, e.g., from one or more other electronic devices 192 (FIG. 1). At block 310, for example, such a determination may comprise comparing information relating to one or more measured signal parameter(s) with one or more threshold value(s). In certain example implementations, such threshold values may be pre-defined or may be dynamically determined. At block 312, in certain example implementations, an electronic device may perform process 300 independently (e.g., without assistance of one or more other devices). Conversely, in certain examples, at block 314 process 300 may include some assistance of one or more other devices. At block 316, a position/velocity and/or the like may be estimated (e.g., using one or more positioning functions).

At block 318, operation of at least one positioning function that the electronic device is presently performing may be affected in response to a transition determination at block 302. Here, for example, at block 320, a positioning function may be stopped and/or halted in some manner. Here, for example, at block 322, a parameter, a measurement, some information, a function, a capability, and/or the like operatively associated with a positioning function may be altered in some manner. At block 324, in certain implementations, another positioning function(s) may be initiated. At block 326, a selection/operation of one or more non-radio sensors may be affected. At block 328, a position/velocity and/or the like may be estimated (e.g., using one or more positioning functions as affected at block 318).

In certain example implementations, at block 330, at least a portion of information associated with process 300 may be transmitted to one or more other devices.

Thus, combining the examples of FIG. 1-3, an electronic device 110 may comprise one or more radio receivers 114 to receive one or more wireless signals 180 associated with one or more wireless communication networks 182. At least one processing unit 112 may be provided to determine (at block 302) that electronic device 110 transitioned from a first environment to a second environment based, at least in part, on one or more measured signal parameters associated with the wireless signals, and in response to a determination that the electronic device transitioned from the first environment to the second environment, (at block 318) affect operation of at least one positioning function that the electronic device is presently performing

As described in greater detail below, in certain examples at least one of the received wireless signals 180 may be transmitted by a terrestrial-based wireless signal transmitter 186. In certain instances, such a terrestrial-based wireless signal transmitter may not be associated with an SPS and/or GNSS. Hence, for example, as electronic device 110 transitions from an outdoor environment to an indoor environment it may no longer have adequate access to SPS/GNSS signals, but may have (non-SPS/GNSS) information regarding wireless signals from one or more wireless communication network(s). Based on such other information, for example, certain decisions may be made and positioning operations affected based thereon.

Processing unit(s) 112 may access information 200 stored in memory 122. Such information may be associated with at least one of: a first environment, a second environment, a boundary region, an estimated location, measured signal parameters, a positioning function, other positioning functions, a wireless communication network, and/or non-radio sensors. Here, for example, information 200 may comprise historical signal parameter information associated with at least one of the received wireless signals. Historical signal parameter information may, for example, be associated with at least one other electronic device's receiving such (similar) wireless signals but at an earlier time.

As mentioned previously, in certain example implementations, a positioning function 160 may comprise an SPS and/or GNSS navigation function166. Here, for example, processing units 112 may affect operation of SPS and/or GNSS navigation function 166 based, at least in part, on at least one of the measured signal parameters and corresponding historical signal parameter information associated with at least one of the received wireless signals. For example, processing units 112 may affect operation of SPS and/or GNSS navigation function 166 to selectively (initiate) request/receive assistance from one or more other electronic devices based, at least in part, on at least one of the measured signal parameters 140. For example, processing units 112 may affect an a priori noise measurement 232 and/or an error measurement 234 associated with operation of SPS and/or GNSS navigation function 166 based, at least in part, on at least one of the measured signal parameters 140. For example, processing units 112 may affect at least one signal environment model capability associated with operation of SPS and/or GNSS navigation function 166 based, at least in part, on at least one of the measured signal parameters 140.

As described in greater detail in subsequent sections, in certain example implementations, processing units 112 may estimate a position and/or a velocity of electronic device 110 based, at least in part, on Doppler related information 236 determined using at least one of the measured signal parameters 140 associated with one or more received wireless signals from at least one of the wireless communication networks. In certain example implementations, processing units 112 may selectively affect an SPS and/or GNSS error measurement capability based, at least in part, on signal-to-noise ratio related information determined using at least one of the measured signal parameters 140, e.g., associated with one or more received wireless signals from at least one of the wireless communication networks. In certain example implementations, processing units 112 may affect an SPS and/or GNSS error measurement capability based, at least in part, on signal propagation related information 230, which may be determined using at least one of the measured signal parameters 140, e.g., associated with one or more received wireless signals from at least one of the wireless communication networks. For example, it may be useful to adjust an integration time 248 and/or the like of an SPS and/or GNSS error measurement capability in response to a transition determination.

In still other example implementations, processing units 112 may affect selection and/or operation of SPS and/or GNSS filtering capability 168 based, at least in part, on estimated position and/or velocity information determined using at least one of the measured signal parameters 140, e.g., associated with one or more received wireless signals from at least one of the wireless communication networks. For example, one or more threshold values of an SPS and/or GNSS filtering capability may be adjusted in response to a transition determination. In certain example implementations, processing units 112 may modify at least one weighting parameter or factor associated with SPS and/or GNSS filtering capability 168 based, at least in part, on the measured signal parameters 140, e.g., associated with one or more received wireless signals from at least one of the wireless communication networks. By way of example, navigation function 160 and/or SPS and/or GNSS filtering capability 168 may comprise a filter 170 and/or the like having one or more controlling inputs that may be adjusted in response to a transition determination.

In certain example implementations, processing units 112 may affect an SPS and/or GNSS integration time 248 and/or the like based, at least in part, on estimated position and/or velocity information determined using at least one of the measured signal parameters 140, e.g., associated with one or more received wireless signals from at least one of the wireless communication networks. Processing units 112 may, for example, affect SPS and/or GNSS integration time 248 based, at least in part, on information associated with the second environment.

In certain example implementations, processing units 112 may affect selection and/or operation of one or more non-radio sensors 150 based, at least in part, on estimated position and/or velocity information determined using at least one of the measured signal parameters 140, and/or on information associated with the second environment. For example, an operation of one or more motion detection sensors may be changed in some manner in response to a transition determination.

Some further more specific example implementations will now be described which may allow for a positioning function (e.g., an SPS/GNSS navigation function) and/or the like to be operatively affected (e.g., enhanced, tuned, augmented, altered, etc., as previously described) in some manner as an electronic device transitions from one environment to another environment.

An SPS/GNSS navigation function may, for example, provide capabilities such as acquisition, tracking, positioning, and navigation based on wireless SPS/GNSS signals. In the examples presented herein, an SPS/GNSS navigation function or the like may be selectively affected in some manner based on determining that the electronic device transitioned from one environment to another. Such determination and operative affect may be based, at least in part, on measured signal parameters associated with other (e.g., non-SPS/GNSS) signals. Thus, for example, measured signal parameters may relate to one or more wireless communication networks from which the electronic device's radios may be able to receive wireless signals. For example, an electronic device may be capable of obtaining measured signal parameters associated with a terrestrial-based communication network (e.g., WWAN, WLAN/WiFi, Bluetooth, FM radio, etc.) and/or the like.

By way of the previous examples and still others, an electronic device may monitor and evaluate various wireless signals. For example, measured signal parameters may be based on a set of observed wireless signals (e.g., availability and/or number of radio sources) and/or relative differences between wireless signals. For example, signal strength measurements of various pilot and/or data radio channels (e.g., RSSI, SNR, SINR, Ec/Io, C/NO, etc.) and/or relative differences between such wireless signals may be obtained. For example, time, frequency offset/phase measurements, etc., and/or relative differences between such wireless signals may be obtained.

Some further example wireless communication networks and corresponding example measured signal parameters are presented below by way of further example but not limitation.

In certain example implementations, CDMA, UMTS, and/or other like wireless signals may provide for measured signal parameters, e.g., such as code phase and code channel strengths, and/or RF level observations, e.g., associated with RSSI and/or AFC. Examples may include, a smoothed gradient, local mean and/or a local variance of: a (CDMA) pilot phase and pilot Ec/Io, (UMTS) pilot phase and pilot Ec/Io

(RSCP), RSSI, frequency observations such as information associated with a voltage controlled oscillator accumulator (VCO_Accum) (e.g., which may correspond in some manner to a position Doppler observation), statistical measurements (e.g., mean and variance) of finger positions and/or of signal energies obtained from fingers, a set of Active/Candidate Sets and statistics (e.g., mean and variance) of searcher positions of each PN in a Neighbor Set, and/or certain historical information of various observations and/or measured signal parameters.

In certain example implementations, GSM and/or the like wireless signals may be measured, such as, for example, on a control channel (e.g., Broadcast channel) since such a channel may tend to maintain an almost constant level of transmission power. Examples may include a smoothed gradient, local mean and/or a local variance of: received signal strength such as RXLEV (received signal level) in Network Measurement Report (NMR) RXLEV (RSSI of Broadcast channel), frequency observations such as VCO_Accum, and/or certain historical information of various observations and/or measured signal parameters.

In certain example implementations, WLAN (e.g., WiFi) and/or the like wireless signals may be measured, such as, for example, WLAN signal observation may be made from beacon, probe response, or data frames through passive or active scanning procedures. Examples may include a smoothed gradient, local mean and/or a local variance of: RSSI, a number of access points (APs) and/or the like and/or changes in a set of observed APs (e.g., new and dropped entries, etc.) and/or certain historical information of various observations and/or measured signal parameters.

Based on the example information described herein (e.g., measured signal parameters, etc.), in response to a transition determination, a positioning function may, for example, be affected in various useful ways. For example, based at least in part on measured signal parameters (e.g., observed/processed terrestrial wireless signals and various derived quantities) an SPS/GNSS navigation function may be operatively affected to detect a general context and/or related multipath environment (e.g. static, walking, driving or user speed; indoor vs. outdoor; or dense urban, urban, suburban, rural, highway, etc.).

In an example implementation, based at least in part on measured signal parameters (e.g., observed/processed terrestrial wireless signals and various derived quantities) an SPS/GNSS navigation function may be operatively affected to dynamically utilize such context information for adjustment of acquisition and/or tracking thresholds. For example, an SPS/GNSS navigation function may dynamically adjust/modify process noise and stochastic models in SPS/GNSS filtering capabilities, e.g., based, at least in part, on wireless communication network signal measurements.

For example, based at least in part on measured signal parameters (e.g., observed/processed terrestrial wireless signals and various derived quantities) an SPS/GNSS navigation function may be operatively affected to dynamically modify/adjust a priori noise/errors of SPS/GNSS measurements (e.g., pseudorange (PR), pseudo range rate (PRR), etc.).

For example, based at least in part on measured signal parameters (e.g., observed/processed terrestrial wireless signals and various derived quantities) an SPS/GNSS navigation function may be operatively affected to dynamically adjust/modify selection of positioning functions and/or other resources for positioning availability, accuracy, and/or power efficiency.

For example, based at least in part on measured signal parameters (e.g., observed/processed terrestrial wireless signals and various derived quantities) an SPS/GNSS navigation function may be operatively affected to dynamically adjust/modify request and response of positioning assistant data for GNSS.

The above example techniques may be employed for an enhanced standalone SPS/GNSS operation. However, if transmitter location information (e.g., base station, AP, etc.) coordinates are available (e.g., obtained via MS-based, A-GNSS assistance operation, etc.), then further integration opportunities may arise (e.g., an MS-based hybrid positioning system), for example, both with ranges and RSSI.

In certain example implementations, historical information regarding the signaling environment may be obtained and used. Such historical information may be associated with one or more electronic devices and may be used, for example, to provide statistical significance when combined with current measurements, which may allow for improved performance, e.g., such as by allowing for shorter duration measurements. In other words, a positioning function may augment current measurements with historical information.

In an example environment transition between outdoor/indoor may occur while a mobile station is moved into a building in which a perceivable change may occur in wireless signals received (e.g., communication and/or broadcasting). Some potential perceivable changes in measured signal parameters, for example, in a cellular network (e.g., downlink signal) while a mobile station is moved into a concrete building may include a change in RSSI, a change in finger tracking, a reduced code phase variance, and/or the like.

For example, a drop in RSSI (e.g., in mean and/or median of RSSI) and an increase in measured variance of RSSI may occur as a cellular-downlink signal may be further attenuated and/or reflected in some manner by building walls (e.g., possible arriving via multipath). Hence, based at least in part on such observations a determination may be made that an environment transition is occurring or has occurred.

In certain situations, there may be a detectable loss of one or more strong paths tracked by finger(s) as a mobile station enters into a building and/or the like, and/or with a pilot Ec/Io change may occur at all of the finger tracked paths. Hence, based at least in part on such observations a determination may be made that an environment transition is occurring or has occurred.

In certain situations, 1x TDOA (or UMTS OTDOA) from a search observation may not undergo a monotonous increase or decrease as long as the mobile station remains inside a building and/or is stationary. Here, it may be assumed, for example, that a relative base station clock drift is negligible for a period, e.g., in a UMTS network. In certain examples, TDOA/OTDOA information may be corrupted by multipath signals, but there may be (rarely) a significant mean gradient and variance change as long as the mobile station remains inside a small area. Hence, based at least in part on such observations a determination may be made that an environment transition is occurring or has occurred.

In certain situations, the above cellular observations may be expected while a mobile station transitions into a building with no repeaters, e.g., no Femto-cells, Pico-cells, etc., arranged inside. However, the existence of such repeaters may be observed to provide a distinctive indication of individual buildings or other like enclosed structure and support a determination that an environment transition is occurring or has occurred. For example, a sudden change in certain measured signal parameters may be monitored and recorded/reported on a mobile station or on a server for utilization, discovery, or registration of these non-macrocell transmitters. In particular, discovered and registered repeaters on a server may be brought to the attention of other mobile stations, e.g., as a part of positioning assistant information and may be more accurately described based on further accumulation of mobile observations. By way of further example, if a building has a repeater, a mobile station may make one or more of the following observations: a sudden unique strongest path, a unique strongest path suddenly appears and Ec/Io values of other previously tracked paths drop at about the same time, a noticeable code phase shift, a suddenly appeared unique strongest path has a noticeable delay compared to previously tracked paths, a noticeable frequency offset and/or stability change, beacons potentially present different signal characteristics such as frequency offset or frequency stability, a suddenly appeared unique strongest path may have a noticeable difference in frequency offset or standard deviation from previously tracked paths, a frequency channel change may happen, and/or a strong signals from a repeater may appear in a same channel or different channels.

In certain example implementations, environment transitions may be perceived based, at least in part, on scatterer distribution effects observed in measured signal parameters. For example, RSSI may be observed as varying (fluctuating) due to movement or due to moving objects around a mobile station. Therefore, a variance of RSSI may be an interesting metric to infer a scatterer density around the mobile station. In other examples, scattering density and/or scatterer distribution of an environment may be inferred via monitor temporal measurements. In general, for example, a distribution of TDOA may depend on a scatterer distribution around the mobile station. In other words, for example an observed TDOA may have wider distribution in urban environments than it might in rural environments. This effect may be utilized, for example, to perceive a transition relating to an outdoor (scattering) environment. Similar, information relating to SPS/GNSS signal scattering density may also be considered in a like manner

In certain example implementations, a density or number of WiFi APs and/or other like wireless signal transmitters may relate to a density of buildings, etc., with an environment (e.g., an urban environment, a building, etc.).

In certain example implementations, a Cell-ID and almanac obtained from a base transceiver station and/or the like may be used to estimate a scatterer distribution for the GNSS satellites in the statistical sense. This might comprise, for example, some computation to estimate a TOA distribution given the GIS. However, a pre-computation may be possible.

In certain example implementations, an environment transition may be determined based, at least in part, on measured signal parameters associated with a cellular density. For example, with Cell-ID and almanac of a base transceiver station and/or the like a cell-size may be roughly estimated from the base station density and a maximum clock error from the cellular network (synchronized). In certain example situations, TDOA values may have a wider possible range while a mobile station resides in a rural (large) cell than while it is in the urban (small) cell. For example, if neighbor cells of the mobile station have 1 Km (about 4 chips in 1x CDMA) cell radius, TDOA values observed within a two base station coverage area may be within [−4˜+4] chips.

If neighbor cells of the mobile station have 5 Km (about 20 chips) cell radius, TDOA values observed within a two base station coverage area may be within [−20˜+20] chips.

Thus, for example, in certain implementations, observed network density (e.g., WiFi density/availability, Cell-ID density/availability, maximum TDOA range, etc.) may be used, at least on part, to determine that an environment transition has occurred (e.g., from an urban versus rural navigation/positioning environment).

In other examples, a velocity or stationary/moving state may be observed and/or estimated from certain measured signal parameters. For example, a change or lack thereof in a Doppler frequency in a received cellular signal may be observed in certain instances. However, a Doppler measurement in a cellular signal may be easily corrupted by effects of high thermal gradients on a TCXO for example, and/or multipaths may be generated by moving cars that are coming towards or going away from a mobile station may produce a high Doppler observation. Nonetheless, in certain instances it is believed that a local average of Doppler frequency measurements may be highly correlated with velocity of a mobile station. Thus, for example, errors due to thermal gradients may be compensated or averaged-out over a longer term observation, and miscellaneous measurement noises and multipath effects may be assumed to have symmetrical distribution so that they may be averaged-out with a smoothing filter and/or the like. As previously mentioned, in certain implementations a VCO_Accum value and/or the like may be significantly correlated with a velocity of a mobile station. Hence, based at least in part on such observations a determination may be made that an environment transition is occurring or has occurred.

In certain other example implementations, cellular down link signals and SPS/GNSS signals may propagate through a distribution of nearby objects (buildings, mostly) but have different elevation angles. In certain instances, it is believed that scatterer distribution of SPS/GNSS signals with very low elevation angles generally have a wide multipath delay distribution which may be about same multipath delay distribution of a down link CDMA paths. Through the same environment, a scatterer distribution of SPS/GNSS signals with higher elevation angle may become narrower as the elevation angle increases. Therefore, one may generalize this to estimate a distribution of a-priori errors of GNSS measurements, for example, from different elevations from the observation of cellular signals in a temporal domain (e.g., temporal measurements such as TOA, TDOA). Hence, based at least in part on such observations a determination may be made that an environment transition is occurring or has occurred.

In certain example implementations, it may be useful to select different process noise and dynamic models depending on user context (stationary, walking, or driving) and environment. Context awareness from terrestrial sources, for example, may enhance filter (e.g., a Kalman filter, etc.) performance with these more narrowly defined dynamic models customized per user context. In particular, a velocity estimation may be effectively used to select between dynamic models and/or scale their operating parameters. Thus, for example, one may use a velocity estimation or stationary state detection for zero-velocity update in a filter and/or the like, and/or perform modification of dynamic model uncertainty (e.g., process noise on a filter) depending on a perceived environment (e.g., indoor/outdoor, urban/suburban).

In certain example implementations, such context information may be used to affect operation of a SPS/GNSS navigation function, e.g., with regard to acquisition and/or tracking thresholds. Acquisition and tracking thresholds such as SNR limits may be adaptive based, at least in part, on a perceived environment/context, for example. A mobile station may, for example, in certain environments (e.g., outdoor) use a higher SNR threshold value to maintain higher accuracy without significant loss of availability. On the other hand, a mobile station in other environments (e.g., indoor) may improve availability by lowering a SNR threshold value (at risk of high range errors).

In certain example implementations, an SPS/GNSS integration time (e.g., associated with a correlation of peak detections) and/or the like may be affected in some manner based, at least in part, on an environment transition (e.g., perceived by velocity, context, etc.). For example, if a mobile station is in an environment that tends to promote lower-mobility or stationary activity, then an integration time may be extended. Conversely, for example, if a mobile station is in an environment that tends to promote higher-mobility an integration time may be reduced. Accordingly, such settings may be affected subject to a perceived environment transition and, for example, SPS/GNSS signal acquisition and tracking operations may be adjusted according to the new environment/context. Hence, in certain example implementations, one may adjust acquisition and tracking threshold values (e.g., SNR limits) based, at least in part, on a determination that an environment transition has occurred, and/or one may adjust an SPS/GNSS integration time based, at least in part, on a determination that an environment transition has occurred.

In certain further example implementations, one may affect selection of positioning resources for positioning availability and/or accuracy and/or power efficiency. By way of example, consider wireless signals associated with a WiFi and a GNSS. In certain instances, it may be that WiFi-based positioning services support lower-mobility mobile stations (e.g., while indoors or in dense urban areas) better than higher mobility mobile stations (e.g., outdoors or on highway), while GNSS tends to work better outdoors and support higher-mobility users well. As such, depending on a perceived environment/context (e.g., indoor or outdoor; lower or higher mobility), a particular type of positioning function (e.g., between a GNSS navigation function and a WiFi navigation function) may be adaptively selected and/or other affected in some manner, e.g., to reduce power consumption and/or improve performance. Similarly, other non-radio sensors based positioning functions, such as inertial sensors, barometers, and magnetometers may be selected and/or otherwise operatively affected in some manner based, at least in part, in response to an environment/context transition.

In still other example implementations, one may adjust/modify a request and response process for positioning assistance data for GNSS and other positioning sensors in some manner based, at least in part, on an environment transition determination. For example, in assisted positioning, aiding information may be adaptive to an environment/context. Hence, for example, an assistance server may collect certain more relevant aiding information and provide such to a mobile station. In certain instances, for example, such aiding information may comprise acquisition assistance information such as SNR limits, a list of available ranging sources, clock time and frequency offsets tied to types of positioning resources such as WiFi or GNSS, and/or suggested selection of positioning function(s).

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,” “determining”, “establishing”, “obtaining”, “generating”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising: with an electronic device:
determining that said electronic device is transitioning or has transitioned from a first environment to a second environment based, at least in part, on one or more measured signal parameters associated with one or more received wireless signals associated with one or more wireless communication networks;
associating at least one of said one or more measured signal parameters with at least one operative parameter that affects operation of an SPS navigation function; and
in response to a determination that said electronic device is transitioning or has transitioned from said first environment to said second environment, affecting operation of said SPS navigation function, at least in part, by changing said at least one operative parameter.

2. The method as recited in claim 1, wherein affecting operation of said SPS navigation function further comprises:
affecting said operation of said SPS navigation function based, at least in part, on at least one of said one or more measured signal parameters and corresponding historical signal parameter information associated with at least one of said one or more received wireless signals.

3. The method as recited in claim 2, wherein affecting operation of said SPS navigation function further comprises:
obtaining at least a portion of said historical signal parameter information from one or more other electronic devices.

4. The method as recited in claim 1, wherein affecting operation of said SPS navigation function further comprises:
affecting said operation of said SPS navigation function to obtain assistance from one or more other electronic devices based, at least in part, on at least one of said one or more measured signal parameters.

5. The method as recited in claim 1, wherein affecting operation of said SPS navigation function further comprises:
affecting at least one of an a priori noise measurement and/or an error measurement associated with said operation of said SPS navigation function based, at least in part, on at least one of said one or more measured signal parameters.

6. The method as recited in claim 1, wherein affecting operation of said SPS navigation function further comprises:
affecting at least one signal environment model capability associated with said operation of said SPS navigation function based, at least in part, on at least one of said one or more measured signal parameters.

7. The method as recited in claim 1, wherein determining that said electronic device is transitioning or has transitioned from said first environment to said second environment further comprises:
estimating at least one of a position and/or a velocity of said electronic device based, at least in part, on Doppler related information determined using at least one of said one or more measured signal parameters.

8. The method as recited in claim 1, wherein affecting operation of said SPS navigation function further comprises:
affecting an SPS error measurement capability based, at least in part, on signal-to-noise ratio related information determined using at least one of said one or more measured signal parameters.

9. The method as recited in claim 1, wherein affecting operation of said SPS navigation function further comprises:
affecting an SPS error measurement capability based, at least in part, on signal propagation related information determined using at least one of said one or more measured signal parameters.

10. The method as recited in claim 1, wherein affecting operation of said SPS navigation function further comprises:
affecting selection and/or operation of an SPS filtering capability based, at least in part, on at least one of estimated position and/or velocity information determined using at least one of said one or more measured signal parameters.

11. The method as recited in claim 10, wherein affecting said SPS filtering capability comprises:
modifying at least one weighting parameter associated with said SPS filtering capability based, at least in part, on at least one of said one or more measured signal parameters.

12. The method as recited in claim 10, wherein said SPS filtering capability comprises at least one of: a Kalman filter, an extended Kalman filter, unscented Kalman filter, a Particle filter, and/or a Bayes filter.

13. The method as recited in claim 1, wherein affecting operation of said SPS navigation function further comprises:
affecting an SPS integration time based, at least in part, on at least one of estimated position and/or velocity information determined using at least one of said one or more measured signal parameters.

14. The method as recited in claim 1, wherein affecting operation of said SPS navigation function further comprises:
affecting an SPS integration time based, at least in part, on information associated with said second environment.

15. The method as recited in claim 1, wherein affecting operation of said SPS navigation function further comprises:
affecting selection and/or operation of one or more non-radio sensors based, at least in part, on at least one of estimated position and/or velocity information determined using at least one of said one or more measured signal parameters.

16. The method as recited in claim 1, wherein affecting operation of said SPS navigation function further comprises:
affecting selection and/or operation of one or more non-radio sensors based, at least in part, on information associated with said second environment.

17. An apparatus for use in an electronic device, the apparatus comprising:
one or more radio receivers to receive one or more wireless signals associated with one or more wireless communication networks;
at least one processing unit to:
determine that said electronic device is transitioning or has transitioned from a first environment to a second environment based, at least in part, on one or more measured signal parameters associated with said one or more wireless signals,
associate at least one of said one or more measured signal parameters with at least one operative parameter that affects operation of an SPS navigation function being performed using said electronic device, and,
in response to a determination that said electronic device is transitioning or has transitioned from said first environment to said second environment,
affect operation of said SPS navigation function, at least in part, by changing said at least one operative parameter.

18. The apparatus as recited in claim 17, said one or more processing units to affect operation of said SPS navigation function based, at least in part, on at least one of said one or more measured signal parameters and corresponding historical signal parameter information associated with at least one of said one or more received wireless signals.

19. The apparatus as recited in claim 18, said one or more radio receivers to receive at least a portion of said historical signal parameter information from one or more other electronic devices.

20. The apparatus as recited in claim 17, said one or more processing units to affect operation of said SPS navigation function to initiate obtaining assistance from one or more other electronic devices based, at least in part, on at least one of said one or more measured signal parameters.

21. The apparatus as recited in claim 17, said one or more processing units to affect at least one of an a priori noise measurement and/or an error measurement associated with said operation of said SPS navigation function based, at least in part, on at least one of said one or more measured signal parameters.

22. The apparatus as recited in claim 17, said one or more processing units to affect at least one signal environment model capability associated with said operation of said SPS navigation function based, at least in part, on at least one of said one or more measured signal parameters.

23. The apparatus as recited in claim 17, said one or more processing units to estimate at least one of a position and/or a velocity of said electronic device based, at least in part, on Doppler related information determined using at least one of said one or more measured signal parameters.

24. The apparatus as recited in claim 17, said one or more processing units to selectively affect an SPS error measurement capability based, at least in part, on signal-to-noise ratio related information determined using at least one of said one or more measured signal parameters.

25. The apparatus as recited in claim 17, said one or more processing units to affect an SPS error measurement capability based, at least in part, on signal propagation related information determined using at least one of said one or more measured signal parameters.

26. The apparatus as recited in claim 17, said one or more processing units to affect selection and/or operation of an SPS filtering capability based, at least in part, on estimated position and/or velocity information determined using at least one of said one or more measured signal parameters.

27. The apparatus as recited in claim 17, said one or more processing units to modify at least one weighting parameter associated with said SPS filtering capability based, at least in part, on said at least one of one or more measured signal parameters.

28. The apparatus as recited in claim 17, wherein said SPS filtering capability comprises at least one of: a Kalman filter, an extended Kalman filter, unscented Kalman filter, a Particle filter, and/or a Bayes filter.

29. The apparatus as recited in claim 17, said one or more processing units to affect an SPS integration time based, at least in part, on at least one of estimated position and/or velocity information determined using at least one of said one or more measured signal parameters.

30. The apparatus as recited in claim 17, said one or more processing units to affect an SPS integration time based, at least in part, on information associated with said second environment.

31. The apparatus as recited in claim 17, said one or more processing units to affect selection and/or operation of one or more non-radio sensors based, at least in part, on at least one of estimated position and/or velocity information determined using at least one of said one or more measured signal parameters.

32. The apparatus as recited in claim 17, said one or more processing units to affect selection and/or operation of one or more non-radio sensors based, at least in part, on information associated with said second environment.

33. An article comprising:
a computer readable storage medium having stored thereon computer implementable instructions executable by one or more processing units to:
determine that an electronic device is transitioning or has transitioned from a first environment to a second environment based, at least in part, on one or more measured signal parameters associated with one or more received wireless signals associated with one or more wireless communication networks;
associate said one or more measured signal parameters with at least one operative parameter that affects operation of an SPS navigation function being performed using said electronic device; and
in response to a determination that said electronic device is transitioning or has transitioned from said first environment to said second environment, affect operation of said SPS navigation function, at least in part, by changing said at least one operative parameter.

34. The article as recited in claim 33, said computer implementable instructions are further executable by said one or more processing units to affect said operation of said SPS navigation function based, at least in part, on at least one of said one or more measured signal parameters and corresponding historical signal parameter information associated with at least one of said one or more received wireless signals.

35. The article as recited in claim 33, said computer implementable instructions are further executable by said one or more processing units to affect said operation of said SPS navigation function to obtain assistance from one or more other electronic devices based, at least in part, on at least one of said one or more measured signal parameters.

36. The article as recited in claim 33, said computer implementable instructions are further executable by said one or more processing units to affect at least one of an a priori noise measurement and/or an error measurement associated with said operation of said SPS navigation function based, at least in part, on at least one of said one or more measured signal parameters.

37. The article as recited in claim 33, said computer implementable instructions are further executable by said one or more processing units to affect at least one signal environment model capability associated with said operation of said SPS navigation function based, at least in part, on at least one of said one or more measured signal parameters.

38. The article as recited in claim 33, said computer implementable instructions are further executable by said one or more processing units to determine that said electronic device has transitioned from said first environment to said second environment by at least one of an estimated position and/or velocity of said electronic device as determined based, at least in part, on Doppler related information determined using at least one of said one or more measured signal parameters.

39. The article as recited in claim 33, said computer implementable instructions are further executable by said one or more processing units to affect an SPS error measurement capability based, at least in part, on signal-to-noise ratio related information determined using at least one of said one or more measured signal parameters.

40. The article as recited in claim 33, said computer implementable instructions are further executable by said one or more processing units to affect an SPS error measurement capability based, at least in part, on signal propagation related information determined using at least one of said one or more measured signal parameters.

41. The article as recited in claim 33, said computer implementable instructions are further executable by said one or more processing units to affect selection and/or operation of an SPS filtering capability based, at least in part, on at least one of estimated position and/or velocity information determined using at least one of said one or more measured signal parameters.

42. The article as recited in claim 41, said computer implementable instructions are further executable by said one or more processing units to modify at least one weighting parameter associated with said SPS filtering capability based, at least in part, on said one or more measured signal parameters.

43. The article as recited in claim 41, wherein said SPS filtering capability comprises at least one of: a Kalman filter, an extended Kalman filter, unscented Kalman filter, a Particle filter, and/or a Bayes filter.

44. The article as recited in claim 33, said computer implementable instructions are further executable by said one or more processing units to affect an SPS integration time based, at least in part, on at least one of estimated position and/or velocity information determined using at least one of said one or more measured signal parameters.

45. The article as recited in claim 33, said computer implementable instructions are further executable by said one or more processing units to affect an SPS integration time based, at least in part, on information associated with said second environment.

46. The article as recited in claim 33, said computer implementable instructions are further executable by said one or more processing units to affect selection and/or operation of one or more non-radio sensors based, at least in part, on at least one of estimated position and/or velocity information determined using at least one of said one or more measured signal parameters.

47. The article as recited in claim 33, said computer implementable instructions are further executable by said one or more processing units to affect selection and/or operation of one or more non-radio sensors based, at least in part, on information associated with said second environment.

48. An apparatus for use in an electronic device, the apparatus comprising:
means for determining that the electronic device is transitioning or has transitioned from a first environment to a second environment based, at least in part, on one or more measured signal parameters associated with one or more wireless signals received from one or more wireless communication networks;
means for associating at least one of said one or more measured signal parameters with at least one operative parameter that affects operation of an SPS navigation function; and
means for affecting operation of said SPS navigation function, at least in part, by changing said at least one operative parameter in response to a determination that said electronic device is transitioning or has transitioned from said first environment to said second environment.

49. The apparatus as recited in claim 48, further comprising:
means for affecting operation of said SPS navigation function based, at least in part, on at least one of said one or more measured signal parameters and corresponding historical signal parameter information associated with at least one of said one or more wireless signals.

50. The apparatus as recited in claim 48, further comprising:
means for receiving at least a portion of said historical signal parameter information from one or more other electronic devices.

51. The apparatus as recited in claim 48, said means for affecting operation of said SPS navigation function comprises means for obtaining assistance from one or more other electronic devices based, at least in part, on at least one of said one or more measured signal parameters.

52. The apparatus as recited in claim 48, further comprising:
means for affecting at least one of an a priori noise measurement and/or an error measurement associated with said operation of said SPS navigation function based, at least in part, on at least one of said one or more measured signal parameters.

53. The apparatus as recited in claim 48, further comprising:
means for affecting at least one signal environment model capability associated with said operation of said SPS navigation function based, at least in part, on at least one of said one or more measured signal parameters.

54. The apparatus as recited in claim 48, further comprising:
means for estimating at least one of a position and/or a velocity of said electronic device based, at least in part, on Doppler related information determined using at least one of said one or more measured signal parameters.

55. The apparatus as recited in claim 48, further comprising:
means for affecting an SPS error measurement capability based, at least in part, on signal-to-noise ratio related information determined using at least one of said one or more measured signal parameters associated.

56. The apparatus as recited in claim 48, further comprising:
means for affecting an SPS error measurement capability based, at least in part, on signal propagation related information determined using at least one of said one or more measured signal parameters.

57. The apparatus as recited in claim 48, further comprising:
means for affecting selection and/or operation of an SPS filtering capability based, at least in part, on at least one of estimated position and/or velocity information determined using at least one of said one or more measured signal parameters.

58. The apparatus as recited in claim 57, further comprising:
means for modifying at least one weighting parameter associated with said SPS filtering capability based, at least in part, on at least one of said one or more measured signal parameters.

59. The apparatus as recited in claim 48, further comprising:
means for affecting an SPS integration time based, at least in part, on at least one of estimated position and/or velocity information determined using at least one of said one or more measured signal parameters.

60. The apparatus as recited in claim 48, further comprising:
means for affecting an SPS integration time based, at least in part, on information associated with said second environment.

61. The apparatus as recited in claim 48, further comprising:
means for affecting selection and/or operation of one or more non-radio sensor means based, at least in part, on at least one of estimated position and/or velocity information determined using at least one of said one or more measured signal parameters associated.

62. The apparatus as recited in claim 48, further comprising:
means for affecting selection and/or operation of one or more non-radio sensor means based, at least in part, on information associated with said second environment.
